(19) United States
(12) Patent Application Publication
(10) Pub. No.: US 2026/0178932 A1
(43) Pub. Date: Jun. 25, 2026

(54) METHOD AND DEVICE FOR PERFORMING FEDERATED LEARNING IN SATELLITE COMMUNICATION SYSTEM

(71) Applicant: University-Industry Cooperation Group of Kyung Hee University, Gyeonggi-do (KR)

(72) Inventors: CHOONG SEON HONG, Gyeonggi-do (KR); NGUYEN XUANLOC, Gyeonggi-do (KR); JI SU YOON, Gyeonggi-do (KR)

(21) Appl. No.: 19/400,386

(22) Filed: Nov. 25, 2025

(30) Foreign Application Priority Data
Dec. 23, 2024 (KR) 10-2024-0194726

(51) Int. Cl. G06N 3/098; G06F 18/21; G06N 3/045; H04B 7/185

(52) U.S. Cl. CPC G06N 3/098; G06F 18/217; G06N 3/045; H04B 7/18517

(57) ABSTRACT

A method for performing federated learning in a satellite communication system includes receiving, at a base station device, association information from each of all satellites within a coverage, setting, one or more satellites available for training among the connected satellites as training satellites based on the received association information, generating, training information for each of the training satellites based on the received association information, transmitting, the generated training information and a global neural network model to each of the training satellites, receiving, each of local neural network models whose training has been completed from the training satellites, and transmitting, the received local neural network models to a server.

### CROSS-REFERENCE TO RELATED APPLICATION AND CLAIM OF PRIORITY

This application claims the benefit under 35 USC § 119 of Korean Patent Application No. 10-2024-0194726, filed on Dec. 23, 2024, in the Korean Intellectual Property Office, the entire disclosure of which is incorporated herein by reference for all purposes.

### BACKGROUND

### 1. Field

Embodiments of the present disclosure relate to a technique for performing federated learning in a satellite communication system.

### 2. Description of Related Art

Satellites may be classified into low Earth orbit satellites, medium Earth orbit satellites, polar orbit satellites, and geostationary orbit satellites according to their orbits around the Earth, and the geostationary orbit satellites may communicate with ground stations 24 hours a day, but all satellites orbiting the Earth, except for geostationary orbit satellites, pass over ground stations at specific times and may communicate with ground stations during the specific times.

These satellites are equipped with mission instruments such as optical cameras, radio imagers, infrared cameras, and multispectral cameras depending on their purpose, and satellite image data acquired through the mission instruments may be used to produce maps and observe, monitor, or predict terrain changes, facility detection, cloud movement, weather conditions, changes in the marine environment, and the like.

Meanwhile, in order to globally expand the coverage of providing wireless connections of electronic devices in wireless communication systems, satellite networks and terrestrial networks are being developed into an integrated form. In addition, attempts to incorporate artificial intelligence (AI) technology into wireless communication systems are rapidly increasing.

In particular, in wireless communication systems using low Earth orbit satellites, federated learning (FL), which is one technique of a distributed learning, may be performed to implement various artificial intelligence services.

However, when implementing federated learning using such satellite communication systems, communication problems may arise in a satellite-ground communication channel between a satellite and the ground, which exhibit significant loss and scattering, and a communication bottleneck problem may occur when many satellites are simultaneously accessing.

Examples of related art include Korean Patent Laid-Open Publication No. 10-2023-0066020 (dated May 12, 2023).

### SUMMARY

Embodiments of the present disclosure are directed to providing a method and apparatus for performing federated learning in a satellite communication system.

In one general aspect, there is provided a method for performing federated learning in a satellite communication system that is performed by a computing device including one or more processors and a memory configured to store one or more programs executed by the one or more processors, the method including receiving, at a base station device, association information from each of all satellites within a coverage, setting, at the base station device, one or more satellites available for training among the connected satellites as training satellites based on the received association information, generating, at the base station device, training information for each of the training satellites based on the received association information, transmitting, at the base station device, the generated training information and a global neural network model to each of the training satellites, receiving, at the base station device, each of local neural network models whose training has been completed from the training satellites, and transmitting, at the base station device, the received local neural network models to a server.

The receiving of the association information may further include establishing, at the base station device, connections to all satellites within the coverage upon receiving the global neural network model from the server, at a point in time at which the global neural network model is received, and requesting, at the base station device, the association information from each of the connected satellites.

The setting of the satellites as the training satellites may further include calculating, at the base station device, one epoch and a window time for each of the connected satellites based on the received association information, determining, at the base station device, whether the connected satellites are available for training while moving through the coverage based on the calculated epoch and window time, and setting, at the base station device, the satellites determined to be available for training as the training satellites according to a determination result.

The method may further include training, at the training satellite, the global neural network model based on the received training information using local data to generate the local neural network model and training result information and transmitting, at the training satellite, the generated local neural network model and training result information to the base station device.

The transmitting of the local neural network models to the server may further include performing, at the base station device, performance evaluation of each of the received local neural network models based on the received training result information, selecting, at the base station device, one or more top local neural network models based on a result of the performance evaluation, and transmitting, at the base station device, the one or more selected top local neural network models to the server.

The method may further include receiving, at the server, the one or more selected top local neural network models from one or more base station devices and updating, at the server, the global neural network model based on the received one or more top local neural network models.

In another general aspect, there is provided a computing device including one or more processors, a memory, and one or more programs, in which the one or more programs are stored in the memory and configured to be executed by the one or more processors, and the one or more programs include a command for receiving association information from each of all satellites within a coverage of a base station device, an command for setting one or more satellites available for training among the connected satellites as training satellites based on the received association information, a command for generating training information for each of the training satellites based on the received association information, a command for transmitting the generated training information and a global neural network model to each of the training satellites, a command for receiving each of local neural network models whose training has been completed from the training satellites, and a command for transmitting the received local neural network models to a server.

In still another general aspect, there is provided a computer program stored in a non-transitory computer readable storage medium including one or more commands, in which the commands, when executed by a computing device including one or more processors, cause the computing device to receive association information from each of all satellites within a coverage of a base station device, set one or more satellites available for training among the connected satellites as training satellites based on the received association information, generate training information for each of the training satellites based on the received association information, transmit the generated training information and a global neural network model to each of the training satellites, receive each of local neural network models whose training has been completed from the training satellites, and transmit the received local neural network models to a server.

### BRIEF DESCRIPTION OF THE DRAWINGS

FIG. 1 is a block diagram exemplarily illustrating a computing environment that includes a computing device suitable for use in exemplary embodiments.

FIG. 2 is a diagram schematically illustrating a process of performing federated learning in a satellite communication system according to an embodiment of the present disclosure.

FIG. 3 is a flowchart illustrating a method for performing federated learning in a satellite communication system according to an embodiment of the present disclosure.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice, the intention of a user or operator, or the like. Thus, the definitions should be determined based on the overall content of the present specification. The terms used in the detailed description are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

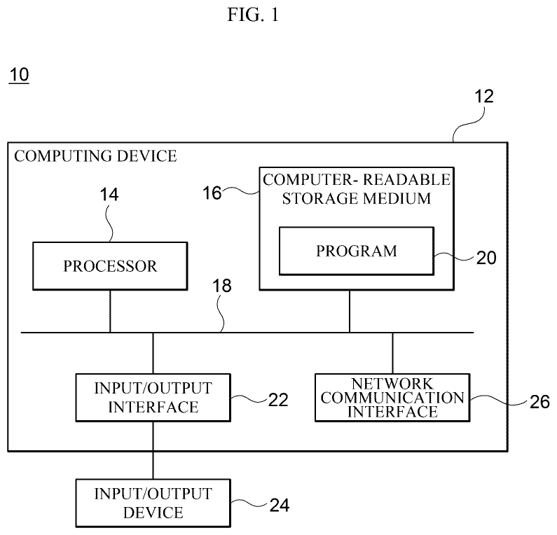

FIG. 1 is a block diagram exemplarily illustrating a computing environment 10 that includes a computing device suitable for use in exemplary embodiments. In the illustrated embodiment, each component may have a different function and capability in addition to those described below, and additional components may be included in addition to those described below.

The illustrated computing environment 10 includes a computing device 12. In an embodiment, the computing device 12 may be a device for providing information using a distributed energy resource management system according to an embodiment of the present disclosure. In an embodiment, the computing device 12 may be a server 10, a base station device 20, or a satellite 30.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In one embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as one of components constituting the computing device 12, or may be connected to a computing device 12 as a separate device distinct from the computing device 12.

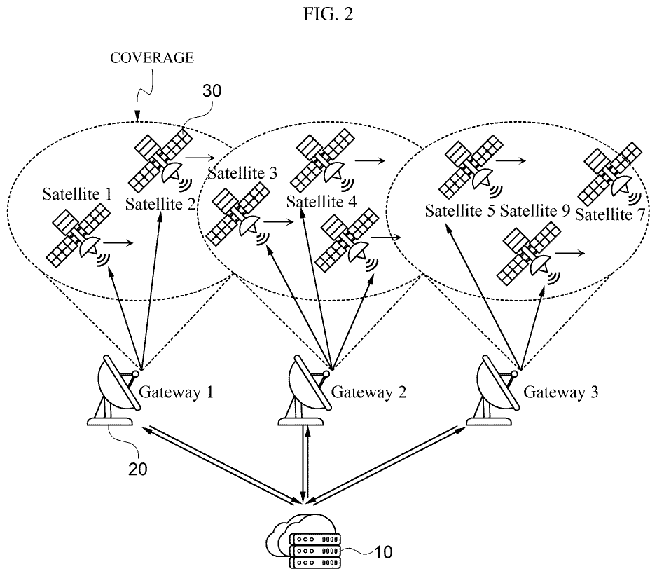

FIG. 2 is a diagram schematically illustrating a process of performing federated learning in a satellite communication system according to an embodiment of the present disclosure.

As illustrated in FIG. 2, when performing federated learning (FL) on a global neural network model (global model) included in a server 10 (cloud server), the server 10 may assign the global neural network model to at least one base station device 20 (gateway), individually. Subsequently, the base station device 20 is connected to one or more satellites 30 within its coverage and transmits the assigned global neural network model to each satellite 30, and the satellites 30 may train local neural network models (local models), which are the transmitted global neural network models, based on training data and a processor individually in each of the satellites 30. Subsequently, each base station device 20 receives the trained local neural network models, and the server 10 may aggregate the local neural network models trained at each base station device and reflect the local neural network models in the global neural network model.

In this case, federated learning may be classified into a local learning step in which each satellite 30 receives and trains the global neural network model, and a global aggregation step in which the server 10 aggregates the trained local neural network models trained by each satellite 30, thereby training the global neural network model.

In this way, by receiving the local neural network models trained by the satellites 30 within the coverage using each base station device 20 and aggregating the local neural network models in the server 10, it is possible to address a communication problem caused by path loss and scattering occurring in a satellite-ground communication channel between the satellite 30 and the ground, and to resolve a communication bottleneck phenomenon occurring when many satellites are simultaneously accessed. Hereinafter, a method for performing federated learning in the satellite communication system according to an embodiment of the present disclosure will be specifically described.

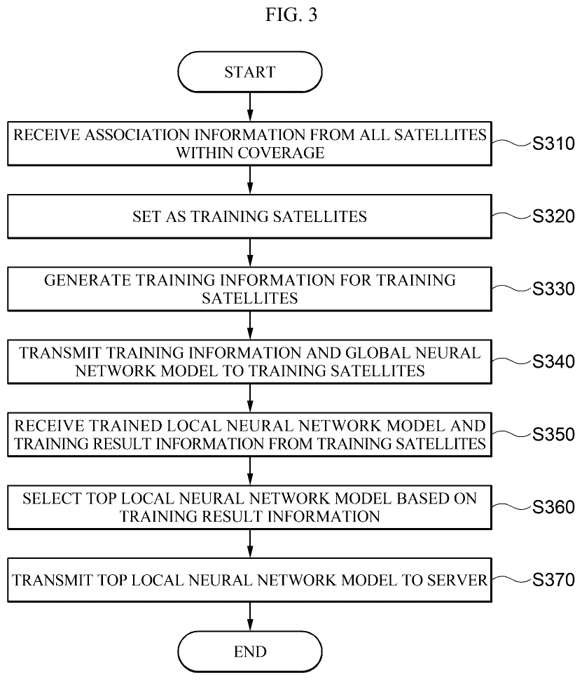

FIG. 3 is a flowchart illustrating a method for performing federated learning in a satellite communication system according to an embodiment of the present disclosure. As described above, the method for performing federated learning in a satellite communication system according to an embodiment of the present disclosure may be performed by a computing device 12 including one or more processors, and a memory storing one or more programs executed by the one or more processors. To this end, the method for performing federated learning in a satellite communication system may be implemented in the form of a program or software including one or more computer-executable instructions and stored in the memory.

Further, in the illustrated flowchart, the method is divided into a plurality of steps; however, at least some of the steps may be performed in a different order, performed together in combination with other steps, omitted, performed in subdivided steps, or performed by adding one or more steps not shown.

Meanwhile, the satellite communication system may include the server 10, the base station devices 20, and the satellites 30.

The server 10 may perform wireless communication with each base station device 20, provide a global learning model to each base station device 20, and aggregate trained local neural network models from each base station device 20 and reflect the trained local neural network models in the global neural network model.

The base station devices 20 may be disposed at certain intervals so that each has a coverage area to cover a specific local area. Each base station device 20 may be associated with satellites 30 in its coverage area.

A plurality of satellites 30 are provided. The satellites 30 may be low earth orbit (LEO) satellites 30. Each satellite 30 may move along an orbit.

In operation 310, the base station device 20 may receive association information from all satellites 30 within its coverage. Specifically, when the base station device 20 receives the global neural network model from the server 10, the base station device 20 may connect to all satellites 30 within the coverage at the time of receiving the global neural network model. In addition, the base station device 20 may request association information from connected satellites 30 and receive association information from connected satellites 30.

In operation 320, the base station device 20 may set satellites 30 available for training based on the received association information as training satellites 30. Specifically, the base station device 20 may determine whether each satellite 30 may be available for training while moving within the coverage area based on the received association information, and may set satellites 30 determined to be available for training as training satellites 30. Here, the association information may include a position, direction, speed, number of pieces of available data, computer capacity within the satellite 30, and amount of available energy of each satellite 30. For example, the base station device 20 may calculate one epoch and a window time for each satellite 30 based on the received association information, and may determine that a satellite 30 available for training at least once during the calculated window time is available for training. This is because, as the satellite 30 moves along an orbit, the satellite 30 has to train the global neural network model using local data of the satellite 30 within the coverage of the base station device 20, and transmit the trained global neural network model back to the base station device 20 before passing through the coverage.

In this case, the base station device 20 may calculate the epoch, the energy consumption used for training, and the window time for the satellite 30 using the following equations.

$${t}_{s} = \frac{{D}_{s} * M}{{C}_{s}} \qquad [ Equation 1 ]$$

(Here, ts denotes one epoch, Ds denotes the number of pieces of training data available on the satellite 30, Cs denotes the computing frequency (clock frequency of the CPU) used by the satellite 30 for training, and M denotes the resource used for training on one data set)

$${E}_{s} = {{ε}_{s} ( {C}_{s} )}^{2} {C}_{d} {D}_{s} \qquad [ Equation 2 ]$$

(Here, Es denotes the energy consumption of the satellite 30 used for training, εs denotes a constant that depends on the CPU mounted on the satellite 30, Cs denotes the computing frequency (clock frequency of the CPU) used by the satellite 30 for training, Cd denotes the number of CPU cycles for training on one data set, and Ds denotes the number of pieces of training data available on the satellite 30)

$${T}_{s} = \frac{DIS}{{v}_{s}} \qquad [ Equation 3 ]$$

(Here, Ts denotes the window time (the time the satellite 30 stays within the coverage of the base station device 20), DIS denotes the remaining distance until passing through the coverage of the base station device 20, and Vs denotes the speed of the satellite 30)

In operation 330, the base station device 20 may generate training information for the training satellite 30 based on the received association information. Specifically, the base station device 20 may generate the number of training iterations and the computing frequency (clock frequency of the CPU) for the training satellite 30 to train the global neural network model based on the received association information. Here, the training information may include the number of training iterations and the computing frequency (clock frequency of the CPU) for the training satellite 30 to train the global neural network model.

In operation 340, the base station device 20 may transmit the generated training information and the global neural network model to the training satellites 30. In this case, the training satellites 30 may train the global neural network model based on the training information received using the local data and computer process of the satellite 30 to generate a local neural network model.

In operation 350, the base station device 20 may receive the trained local neural network model and training information from the training satellites 30. Here, the training result information may include the performance of the local neural network model (loss information), the number of training iterations, and the number of pieces of training data. In this case, the training satellite 30 may train a global neural network model according to the number of training iterations and computing frequency received from the base station device 20 to generate the local neural network model, and may generate the training result information based on the loss information for the model, the number of training iterations, and the number of pieces of training data during the training process.

In operation 360, the base station device 20 may select one or more top local neural network models from among the trained local neural network models based on the training result information. For example, the base station device 20 may perform performance evaluation of the local neural network models based on the loss information, the number of training iterations, and the number of pieces of training data for the local neural network models, and select one or more top local neural network models according to a result of the performance evaluation.

In operation 370, the base station device 20 may transmit the one or more selected top local neural network models to the server 10. In this case, the server 10 may aggregate the top local neural network models received from one or more base station devices 20 and reflect the top local neural network models in the global neural network model included in the server 10. That is, the server 10 may update the performance of the global neural network model to maximize its performance based on the top local neural network models aggregated from the base station devices 20, and may be defined as in the following Equation 4.

$$F = {\sum }_{g = 1}^{G} {W}_{g} {F}_{g} \qquad [ Equation 4 ]$$

(Here, F denotes the updated global neural network model, G is the base station device 20, Fg denotes the model transmitted from the base station device 20, and Wg denotes the coefficient of the model (that is, the weighted contribution of each base station device 20 to the aggregation operation of the server 10)

In addition, the model aggregation in the base station device 20 may be defined as in the following Equation 5.

$${F}_{g} = {\sum }_{s = 1}^{{U}_{g}} {w}_{g} {f}_{g} \qquad [ Equation 5 ]$$

(Here, Fg denotes the model aggregated at the base station device 20, Ug denotes the satellite 30 within the coverage, fg denotes the model transmitted from the satellite 30, and wg denotes the coefficient of the model (that is, the weighted contribution of each satellite 30 to the aggregation operation of the base station device 20)

Therefore, according to embodiments of the present disclosure, by performing federated learning in the satellite communication system, the satellite 30 may train the deep learning model using a vast amount of data collected by the satellite 30 without compromising data privacy.

In addition, according to embodiments of the present disclosure, by using a plurality of base station devices 20, connections to many satellites 30 may be established without waiting for any satellite 30 to complete its orbit, thereby enabling training using abundant data resources so that an artificial intelligence model with better performance is generated.

Meanwhile, in an embodiment of the present disclosure, the base station device 20 may optimize parameters using the following Equation 6 so as to achieve a global neural network model with optimal performance in the server 10.

$$\begin{matrix}[ Equation 6 ] & \\ minimize F ( δ , C , k , w , W ) & ( 6 a )\end{matrix}$$

$$( δ , C , k , w , W ) {δ}_{\text{?}}^{g} ϵ \{ 0 ; 1 \} \qquad ( 6 b )$$

$$subject to {\sum }_{g = 1}^{\text{?}} {δ}_{\text{?}}^{g} \leq 1 \qquad ( 6 c )$$

$${t}_{\text{?}} {k}_{\text{?}} \leq {T}_{\text{?}} \qquad ( 6 d )$$

$$0 \leq {w}_{\text{?}} \leq 1 \qquad ( 6 e )$$

$${\sum }_{\text{?} = 1}^{\text{?}} {w}_{\text{?}} = 1 \qquad ( 6 f )$$

$$0 \leq {W}_{g} \leq 1 \qquad ( 6 g )$$

$${\sum }_{g = 1}^{\text{?}} {w}_{g} = 1 \qquad ( 6 h )$$

$${E}_{\text{?}} {k}_{\text{?}} \leq {E}_{\text{?}}^{m} \qquad ( 6 i )$$

$$\text{?} \text{indicates text missing or illegible when filed}$$

(Here, δ represents whether the training satellite 30 is set, C denotes the CPU performance of the satellite 30, k denotes the number of training iterations performed by each satellite 30, w denotes the weighted contribution of each satellite 30 to the aggregation operation of the base station device 20, and W denotes the weighted contribution of each base station device 20 to the aggregation operation of the server 10)

Here, (6a) may represent obtaining a global neural network model having the lowest loss value (optimal performance) as a target of Equation 6, (6b) may represent whether the training satellite 30 is set in the coverage of the base station device 20 (1 indicates that it is set, 0 otherwise), (6c) may represent a condition that one satellite 30 is connected to only one base station device 20, (6d) may represent a condition that the epoch of the satellite 30 has to be less than the window time (ts is one epoch and ks is the number of training iterations), (6e) and (6f) may represent conditions for limiting the weight contribution of each satellite 30 in the aggregation operation of the base station device 20 (the weight contribution of the training satellite 30 shall 0 or more and 1 or less, and the sum of the weights of the training satellites 30 in the coverage shall be 1), (6g) and (6h) may represent conditions for limiting the weight contribution of each base station device 20 in the aggregation operation of the server 10 (the weight contribution of the base station device 20 shall be 0 or more and 1 or less, and the sum of the weights of all base station devices 20 shall be 1), and (6i) may represent a condition for limiting the energy consumption of the satellite 30 (Es is the energy consumption of the satellite 30 for one training iteration).

That is, the base station device 20 may perform the method for performing federated learning in a satellite communication system according to an embodiment of the present disclosure based on optimized parameters (δ, C, k, w, W), thereby enabling the server 10 to have a global neural network model with optimal performance.

According to embodiments of the present disclosure, by performing federated learning in a satellite communication system, the satellite can train a deep learning model using a vast amount of data collected by the satellite without compromising data privacy.

In addition, according to embodiments of the present disclosure, by using a plurality of base station devices, connections to many satellites can be established without waiting for any satellite to complete its orbit, thereby enabling training using abundant data resources so that an artificial intelligence model with better performance is generated.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. A method for performing federated learning in a satellite communication system performed by a computing device including one or more processors, and a memory configured to store one or more programs executed by the one or more processors, the method comprising:
receiving, at a base station device, association information from each of all satellites within a coverage;
setting, at the base station device, one or more satellites available for training among the connected satellites as training satellites based on the received association information;
generating, at the base station device, training information for each of the training satellites based on the received association information;
transmitting, at the base station device, the generated training information and a global neural network model to each of the training satellites;
receiving, at the base station device, each of local neural network models whose training has been completed from the training satellites; and
transmitting, at the base station device, the received local neural network models to a server.

2. The method of claim 1, wherein the receiving of the association information further includes:
establishing, at the base station device, connections to all satellites within the coverage upon receiving the global neural network model from the server, at a point in time at which the global neural network model is received; and
requesting, at the base station device, the association information from each of the connected satellites.

3. The method of claim 1, wherein the setting of the satellites as the training satellites further includes:
calculating, at the base station device, one epoch and a window time for each of the connected satellites based on the received association information;
determining, at the base station device, whether the connected satellites are available for training while moving through the coverage based on the calculated epoch and window time; and
setting, at the base station device, the satellites determined to be available for training as the training satellites according to a determination result.

4. The method of claim 1, further comprising:
training, at the training satellite, the global neural network model based on the received training information using local data to generate the local neural network model and training result information; and
transmitting, at the training satellite, the generated local neural network model and training result information to the base station device.

5. The method of claim 4, wherein the transmitting of the local neural network models to the server further includes:
performing, at the base station device, performance evaluation of each of the received local neural network models based on the received training result information;
selecting, at the base station device, one or more top local neural network models based on a result of the performance evaluation; and
transmitting, at the base station device, the one or more selected top local neural network models to the server.

6. The method of claim 5, further comprising:
receiving, at the server, the one or more selected top local neural network models from one or more base station devices; and
updating, at the server, the global neural network model based on the received one or more top local neural network models.

7. A computing device comprising:
one or more processors;
a memory; and
one or more programs stored in the memory, the one or more programs configured to be executed by the one or more processors, the one or more programs comprising:
a command for receiving association information from each of all satellites within a coverage of a base station device;
a command for setting one or more satellites available for training among the connected satellites as training satellites based on the received association information;
a command for generating training information for each of the training satellites based on the received association information;
a command for transmitting the generated training information and a global neural network model to each of the training satellites;
a command for receiving each of local neural network models whose training has been completed from the training satellites; and
a command for transmitting the received local neural network models to a server.

8. The computing device of claim 7, wherein the command for receiving the association information further includes:
a command for establishing connections to all satellites within the coverage upon receiving the global neural network from the server, at a point in time at which the global neural network model is received; and
a command for requesting the association information from each of the connected satellites.

9. The computing device of claim 7, wherein the command for setting the one or more satellites as the training satellites further includes:
a command for calculating one epoch and a window time for each of the connected satellites based on the received association information;
a command for determining whether the connected satellites are available for training while moving through the coverage based on the calculated epoch and window time; and
a command for setting the satellites determined to be available for training as the training satellites according to a determination result.

10. The computing device of claim 7, wherein the command for receiving each of local neural network models whose training has been completed further includes a command for receiving the local neural network model and training result information generated through training, at each of the training satellites, the global neural network model based on the received training information using local data.

11. The computing device of claim 10, wherein the command for transmitting the received local neural network models to the server further includes:
a command for performing performance evaluation of each of the received local neural network models based on the received training result information;
a command for selecting one or more top local neural network models according to a result of the performance evaluation; and
a command for transmitting the one or more selected top local neural network models to the server.

12. A computer program stored in a non-transitory computer readable storage medium, comprising:
one or more commands,
wherein the one or more commands, when executed by a computing device including one or more processors, cause the computing device to:
receive association information from each of all satellites within a coverage of a base station device;
set one or more satellites available for training among the connected satellites as training satellites based on the received association information;
generate training information for each of the training satellites based on the received association information;
transmit the generated training information and a global neural network model to each of the training satellites;
receive each of local neural network models whose training has been completed from the training satellites; and
transmit the received local neural network models to a server.
